(19) United States
(12) Patent Application Publication
(10) Pub. No.: US 2017/0119055 A1
(43) Pub. Date: May 4, 2017

(54) ATOMIZATION ASSEMBLY AND ELECTRONIC CIGARETTE

(71) Applicant: KIMREE HI-TECH INC., ROAD TOWN, TORTOLA (VG)

(72) Inventor: Qiuming LIU, SHENZHEN (CN)

(21) Appl. No.: 15/301,574

(22) PCT Filed: Apr. 2, 2014
(86) PCT No.: PCT/CN2014/074674

§ 371 Date: Oct. 3, 2016

(51) Int. Cl. A24F 47/00; H05B 1/02

(52) U.S. Cl. CPC A24F 47/008; H05B 1/0244; H05B 2203/021

(57) ABSTRACT

The present application provides an atomization assembly and an electronic cigarette, the atomization assembly comprises an atomization core and an oil storage element. The atomization core comprises an electrode assembly, an atomization tube configured to sheathe the electrode assembly and insert into the oil storage element. A blocking part is defined on an outer surface of the electrode assembly. An air-vent hole is defined at one end of the blocking part of the electrode assembly close to the battery assembly; the atomization tube is positioned at the other end of the blocking part. In the atomization assembly or the electronic cigarette of the present application, it is hard for the tobacco oil to be leaked to airflow passageway, hard for user to suck condensed tobacco oil and easy for assembling.

### TECHNICAL FIELD

This invention relates to the field of products of electric heaters, and more particularly to an atomization assembly and an electronic cigarette.

### BACKGROUND OF THE INVENTION

The prior electronic cigarette usually includes an atomization assembly and a battery assembly connected to each other. One end of the atomization assembly, opposite to the battery assembly, is used as a mouthpiece for a user to smoke. The atomization assembly comprises a heating wire assembly for atomizing tobacco oil, an oil storage cotton for storing the tobacco oil, and a wick for guiding the tobacco oil to the heating wire assembly. A smoke passageway formed to run through the oil storage cotton is formed in the atomization assembly. Users suck the smoking formed by the heating wire assembly atomizing the tobacco oil via the smoke passageway.

As the position of the oil storage cotton is close to the mouthpiece and the smoke passageway is in an oil storage region, it is easy for the tobacco oil to be leaked to the smoke passageway, and hence the tobacco oil without being atomized is sucked by users. Moreover, it is easy for the user to suck condensed tobacco oil because the tobacco oil is condensed due to the tobacco oil stored in the oil storage region absorbs the heat when the tobacco oil passes through the oil storage region. Therefore, it brings bad experience to users.

Therefore, the prior art has some defects and is needed to be improved.

### SUMMARY OF THE INVENTION

Aiming at above defects of the electronic cigarette in the prior art that it is easy for the tobacco oil to be leaked to the smoke passageway and it is easy for users to suck the tobacco oil due to that the smoke passageway runs through the oil storage region, the technical problem of the present invention to solve is to provide an atomization assembly and an electronic cigarette with which it is hard for the tobacco oil to be leaked to the smoke passageway and hard for users to suck the condensed tobacco oil.

The technical solution of the invention for solving its problem is to provide an atomization assembly configured to assembled with a battery assembly to form an electronic cigarette is provided; the atomization assembly comprises an atomization core and an oil storage element connected to the atomization core and configured to store tobacco oil; one end of the atomization core is inserted into the oil storage element and a smoke outlet configured to discharge smoke is defined at the other end of the atomization core;

The atomization core comprises an electrode assembly electrically connected to the battery assembly, an atomization tube configured to sheathe the electrode assembly and inserted into the oil storage element, and a heating wire assembly electrically connected to the electrode assembly; an atomization cavity configured to contain the heating wire assembly is further defined in the atomization core;

A blocking part is defined on an outer surface of the electrode assembly; an air-vent hole communicated with both an exterior of the atomization assembly and an interior of the atomization cavity is defined on the electrode assembly and close to one end of the blocking part, and the end of the blocking part is close to the battery assembly; the atomization tube is positioned at the other end of the blocking part, and the other end of the blocking part is opposite to the battery assembly.

The atomization core is detachably connected with the oil storage element.

An oil guiding part configured to guide the tobacco oil to the heating wire assembly is defined in one end of the atomization tube and the end of the atomization tube is opposite to the atomization cavity; the tobacco oil is atomized by the heater element; an external wall of the oil guiding part is configured to fit an internal wall of the atomization tube.

The oil storage element comprises a body and a sealing plug configured to be detachably covered on an opening of the body; a baffle is defined in the body; an internal space of the body is divided into an oil storage space and an air flowing space by the baffle; an air inlet configured for the air to flow into the electronic cigarette is defined on a side wall of the air flowing space of the body;

The atomization core is configured to be clasped by the sealing plug and run through both the sealing plug and the baffle to extend to an inside of the oil storage space; the air-vent hole is positioned in the air flowing space.

A sealing part is defined between an outer wall of the atomization tube and the baffle.

The sealing plug comprises a U-shaped connection portion and an abutting portion formed by two open ends of the U-shaped connection portion bending and extending in opposite directions respectively and the U-shaped connection portion of the sealing plug is embedded in the oil storage element.

The air-vent hole is waist-shaped.

An atomization base configured to place the heating wire assembly is further defined in the atomization cavity; a sealing element is defined between an outer wall of the atomization base and an inner wall of the atomization tube.

The atomization base is made of ceramic

The blocking part is an annular flange protruding outwardly from the electrode assembly in the radial direction.

The blocking part is a plurality of protrusions protruding outwardly from the electrode assembly in the radial direction, and a plurality of protrusions is arranged in the same circle.

The oil storage element is transparent.

In another aspect, the present application further provides an atomization assembly configured to be assembled with a battery assembly to form an electronic cigarette; the atomization assembly comprises an atomization core and an oil storage element configured to store tobacco oil and connected to the atomization core; One end of the atomization core is inserted into the oil storage element and a smoke outlet configured to discharge smoke is defined at the other end of the atomization core;

The atomization core comprises an electrode assembly electrically connected to the battery assembly, an atomization tube configured to sheathe the electrode assembly and inserted into the oil storage element, and a heating wire assembly electrically connected to the electrode assembly; an atomization cavity configured to contain the heating wire assembly is further defined in the atomization core;

A blocking part is defined on an outer surface of the electrode assembly; an air-vent hole communicated with both an exterior of the atomization assembly and an interior of the atomization cavity is defined on the electrode assembly and close to one end of the blocking part, and the end of the blocking part is close to the battery assembly; the atomization tube is positioned at the other end of the blocking part, and the other end of the blocking part is opposite to the battery assembly;

The oil storage element comprises a body and a sealing plug configured to be detachably covered on an open end of the body; a baffle is defined in the body; an internal space of the body is divided into an oil storage space and an air flowing space by the baffle; an air inlet configured for air to flow into the electronic cigarette is defined on a side wall of the air flowing space of the body;

The atomization core is configured to be clasped by the sealing plug and run through both the sealing plug and the baffle to extend to an inside of the oil storage space; the air-vent hole is positioned in the air flowing space;

the blocking part is a protrusion part protruding outwardly from the electrode assembly in the radial direction.

In yet another aspect, the present application further provides an electronic cigarette comprising a main body; a mouthpiece, an atomization assembly configured to provide atomized smoke, and a battery assembly configured to power the atomization assembly are defined at the main body; the atomization assembly is defined at one end of the main body and the end of the main body is opposite to the mouthpiece;

The atomization assembly comprises an atomization core and an oil storage element configured to store tobacco oil and connected to the atomization core; one end of the atomization core is inserted into the oil storage element and a smoke outlet configured to discharge smoke is defined at the other end of the atomization core;

The atomization core comprises an electrode assembly electrically connected to the battery assembly, an atomization tube configured to sheathe the electrode assembly and inserted into the oil storage element, and a heating wire assembly electrically connected to the electrode assembly; an atomization cavity configured to contain the heating wire assembly is further defined in the atomization core;

A blocking part is defined on an outer surface of the electrode assembly; an air-vent hole communicated with both an exterior of the atomization assembly and an interior of the atomization cavity is defined on the electrode assembly and close to one end of the blocking part, and the end of the blocking part is close to the battery assembly; the atomization tube is positioned at the other end of the blocking part, and the other end of the blocking part is opposite to the battery assembly.

The oil storage element comprises a body and a sealing plug configured to be detachably covered on an open end of the body; a baffle is defined in the body; an internal space of the body is divided into an oil storage space and an air flowing space by the baffle; an air inlet configured for the air to flow into the electronic cigarette is defined on a side wall of the air flowing space of the body;

The atomization core is configured to be clasped by the sealing plug and run through both the sealing plug and the baffle to extend to an inside of the oil storage space; the air-vent hole is positioned in the air flowing space.

An air outlet is defined on the mouthpiece; an airflow passageway provided for the smoke and the air to flow is defined in the battery assembly; the airflow passageway, the air outlet and the air inlet communicate with each other.

The mouthpiece is detachably connected to the battery assembly.

The connection between any two of the oil storage element, the atomization core and the battery assembly is detachable.

The battery assembly further comprises:

a battery, an airflow sensor configured to generate a pulse signal,

a microcontroller connected to the battery and the airflow sensor respectively and configured to generate a control signal according to the pulse signal;

The microcontroller is connected to the heating wire assembly in order to make the heating wire assembly atomize the tobacco oil according to the control signal.

By implementing the atomization assembly and the electronic cigarette of the present invention, the following advantages may be obtained. By means of the arrangement that the oil storage element and the atomization core cooperate with each other, and one end of the atomization core is inserted into the oil storage element while a smoke outlet is defined at the other end of the atomization core, the smoke passageway for discharging the smoke never runs through the oil storage region. Therefore, it is hard for the tobacco oil to be leaked to the smoke passageway and it is hence hard for users to suck the condensed tobacco oil. Meanwhile, by means of the arrangement that a blocking part is defined on the electrode assembly of the atomization assembly, an air-vent hole connected both to an exterior of the electronic cigarette and an interior of the atomization cavity is defined at one side of the blocking part, opposite to the battery assembly, and the atomization tube is configured to sheathe one end of the blocking part, opposite to the battery assembly, when assembling the atomization tube, the atomization tube can be avoided from being inserted into the position where the air-vent hole is positioned due to the existing of the blocking part. Therefore, it is hard for the air-vent hole to be plugged, which ensures a free air inflow, a stable amount of smoke and a good taste. Moreover, due to the existing of the blocking part, there is no need to observe whether the air-vent hole is aligned or not during assembling, thus it is convenient for assembling, and the producing efficiency is hence improved. In addition, as the atomization assembly is configured at one end of the main body, opposite to the mouthpiece, it is not only hard for users to suck the tobacco oil leaked out, but can also avoid the circumstance in the prior art that it is too hot to hold the electronic cigarette because the atomization assembly is defined at the holding position for the fingers.

### BRIEF DESCRIPTION OF THE DRAWINGS

The present application will be further described with reference to the accompanying drawings and embodiments in the following. In the accompanying drawings:

FIG. 1 illustrates a sectional view of the entire structure of an electronic cigarette in accordance with a first preferred embodiment of the present application;

FIG. 2 illustrates a sectional view of the entire structure of an electronic cigarette in accordance with a second preferred embodiment of the present application;

FIG. 3 illustrates a schematic view of an atomization core shown in FIGS. 1 and 2;

FIG. 4 illustrates a schematic view of an electrode assembly shown in FIG. 3;

FIG. 5 illustrates a section view of an electronic cigarette of the present application with explored structure.

### DETAILED DESCRIPTION OF THE PREFERRED EMBODIMENTS

Aiming at the defects in the prior art that it is easy for the tobacco oil to be leaked to the smoke passageway and it is easy for users to suck the tobacco oil due to that the smoke passageway runs through the oil storage region of an oil storage element 12, an atomization assembly 1 and an electronic cigarette including the atomization assembly 1 are provided. By means of the arrangement that one end of an atomization core 11 is inserted into the oil storage element 12 while a smoke outlet 110 is defined at the other end of the atomization core, it can ensure that the smoke passageway does not run through the oil storage region of the oil storage element 12. Therefore, it is hard for the tobacco oil to be leaked to the smoke passageway and it is hence hard for users to suck the condensed tobacco oil. Meanwhile, by means of the arrangement that a blocking part 115 is defined on an electrode assembly 111 of the atomization assembly 1, it can be ensured that when assembling an atomization tube 112, an air-vent hole 116 can be avoided from being plugged by an unaligned assembly of the atomization tube 112. By implementing the atomization assembly 1 and the electronic cigarette of the present application, a free air inflow, a stable amount of smoke and a good taste can be realized. Moreover, due to the existing of a blocking part 115, there is no need to observe whether the air-vent hole is aligned or not during assembling, thus it is convenient for assembling, and the producing efficiency is hence improved. In addition, as the atomization assembly 1 is configured at one end of a main body of the electronic cigarette, opposite to the mouthpiece, it is not only hard for users to suck the tobacco oil leaked out, but can also avoid the circumstance in the prior art that it is too hot to hold the electronic cigarette because the atomization assembly is defined at the holding position for the fingers.

In order to understand the technical features, objectives and effects of the present application more clearly, the embodiments of the present application will be described in detail in company with the drawings.

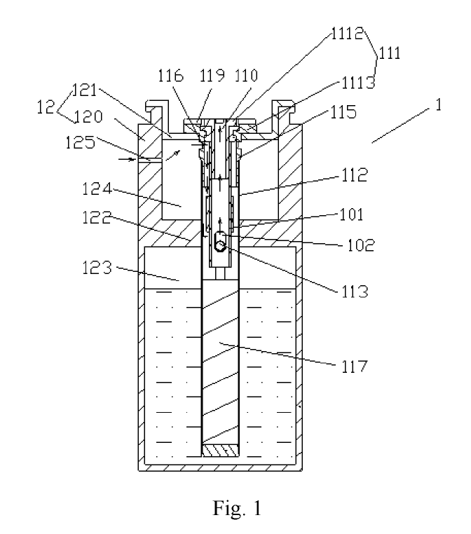

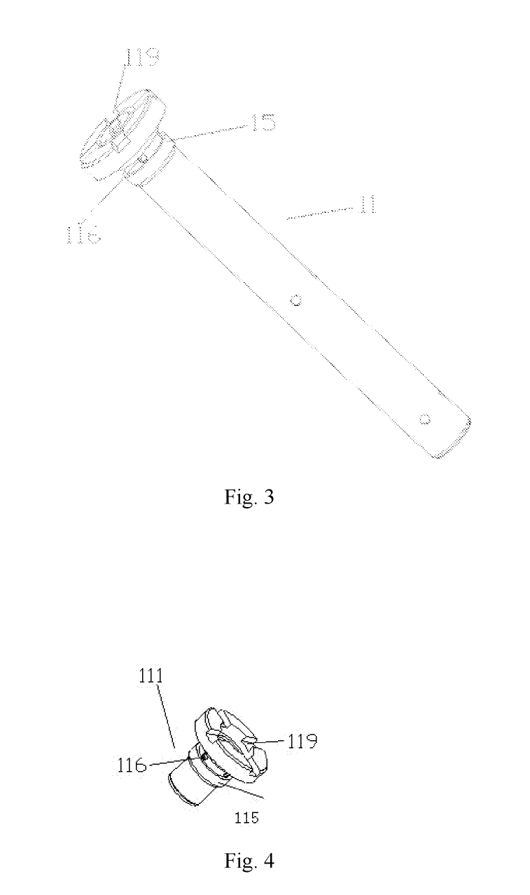

FIG. 1 illustrates an atomization assembly 1 in accordance with a first preferred embodiment of the present application. The present application provides the atomization assembly 1 configured to be assembled with a battery assembly 3 to form an electronic cigarette. The atomization assembly 1 comprises an atomization core 11 (shown in combination with FIG. 3) and an oil storage element 12 connected to the atomization core 11 and configured to store tobacco oil. One end of the atomization core 11 is inserted into the oil storage element 12 while a smoke outlet 11 is defined at the other end of the atomization core.

As shown in combination with FIG. 3, the atomization core 11 comprises an electrode assembly 111 electrically connected to the battery assembly 3, an atomization tube 112 configured to sheathe the electrode assembly 111 and extend to inside the oil storage element 12, and a heating wire assembly 113 electrically connected to the electrode assembly 111. An atomization cavity (not labeled) configured to contain the heating wire assembly 113 is further defined in the atomization core 111. A blocking part 115 is defined on an outer surface of the electrode assembly 111. An air-vent hole 116 communicated with both an exterior of the electronic cigarette and an interior of the atomization cavity (not labeled) is defined on the electrode assembly and close to one end of the blocking part 115, wherein the end of the blocking part 115 is close to the battery assembly 3. The atomization tube 112 is configured to sheathe the other end of the blocking part 115, wherein the other end of the blocking part is opposite to the battery assembly 3.

One end of the atomization core 11 is inserted into the oil storage element 12, and a smoke outlet configured to discharge the smoke is defined at the other end of the atomization core 11. Thus, it can be ensured that the smoke passageway for discharging the smoke will not run through the oil storage region of the oil storage element 12. Therefore, it is hard for the tobacco oil to be leaked to the smoke passageway and the possibility for the user to suck the condensed tobacco oil has been reduced, which leads to good user experience.

Moreover, in the atomization core 11 of the embodiment, due to the existing of the blocking part 115, the atomization tube 112 can be prevented from being inserted into the position where the air-vent hole 116 is positioned when assembling the atomization tube 112. Therefore, it is hard for the air-vent hole 116 to be plugged, which ensures a free inflow, a stable amount of smoke, a good taste and a thorough atomization to the tobacco oil.

Preferably, as shown in FIG. 4, the blocking part 115 is a protrusion part formed by protruding the electrode assembly 111 radially and outwardly. The protrusion part is preferred to be a annular flange protruding outwardly from the electrode assembly 111 in the radial direction.

It should be understood that the blocking part 115 can also be a plurality of protrusions defined on an outer side of the electrode assembly 111, and a plurality of protrusions are arranged in the same circle. In the present embodiment, the configuration of the blocking part 115 is not limited as long as it can be used to block the atomization tube 112 from continuously moving along a direction of a force applied to insert the atomization tube 112 into an external electrode. In addition, the blocking part 115 can also be a blocking part configured to sheathe the electrode assembly 111 and the like, which is not limited here.

Specifically, as shown in FIG. 1, the electrode assembly 111 comprises an external electrode 1112 and an internal electrode 1113 defined in the external electrode 1112 and configured to be insulated from the external electrode 1112. The blocking part 115 is defined outside an outer wall of the external electrode 1112.

The electrode assembly 111 is shaped to be hollow and is connected with the smoke outlet 110 and the atomization cavity respectively. An outflow groove 119 configured to guide the airflow to the battery assembly 3 or other parts to make the airflow finally discharged from the electronic cigarette is formed on a top surface of one end of the electrode assembly 111, wherein the end of the electrode assembly 111 is opposite to the oil storage element 12. The outflow groove 119 and the smoke outlet 110 are connected to each other.

An air-vent tube 101 is further defined inside the atomization core 11. One end of the air-vent tube 101 is configured to sheathe one end of the internal electrode 1113 with an interference fit, wherein the end of the internal electrode 1113 is opposite to the smoke outlet 110. In the present embodiment, the atomization cavity is defined in one end of the air-vent tube 101, wherein the end of the air-vent tube 101 is opposite to the internal electrode 1113. That is, the heating wire assembly 113 is placed in the air-vent tube 101 and is fixed on the air-vent tube 101. A through-hole 102 is defined on a wall of a position at which the heating wire assembly 113 is placed. A gap is defined between the outer peripheral wall of the air-vent tube 101 and the inter wall of the atomization tube 112, in order to make sure that the through-hole 102 and the air-vent hole 116 are connected to each other. The inflow from the air-vent hole 116 is further ensured to flow into the inside of the atomization cavity via the through-hole 102. It should be understood that the heating wire assembly 113 can also be fixed on the electrode assembly 111 or the atomization tube 112, which is not limited here.

The specific configuration of the atomization assembly 1 of the electronic cigarette will be described in detail in the following combined with the embodiment as shown in FIG. 1.

An oil guiding part 117 configured to guide the tobacco oil to the heating wire assembly 113 is defined in one end of the atomization tube 112, wherein the end of the atomization tube 112 is opposite to the atomization cavity. The tobacco oil guided to the heating wire assembly 113 is atomized by the heating wire assembly 113. In the present application, the oil guiding part 117 is preferred to be made of cotton or fiber and the like, which is not limited here. Specifically, an outer surface of the oil guiding part 117 fits an inner wall of the atomization tube 112 well, thus it is hard for the tobacco oil stored in the oil storage space 123 to flow into the atomization cavity via the atomization tube 112 when the atomization assembly is placed upside down.

Specifically, the heating wire assembly 113 comprises a wick and a heating coil twined around the wick. The wick extends to the inside of the oil guiding part 117. Certainly, the heating wire assembly 113 can only comprises the heating coil or a heating leaf The heating coil or the heating leaf is placed at one end of the oil guiding part 117 and atomizes the tobacco oil in the oil guiding part 117 directly, which is not limited here.

Similarly, the specific configuration of the oil storage element 12 of the atomization assembly 1 will be described in detail in the following combined with the embodiment as shown in FIG. 1. The oil storage element 12 comprises a body 120 and a sealing plug 121 configured to be detachably covered on an opening of the body 120. A baffle 122 is defined in the body. An internal space of the body is divided into an oil storage space 123 and an air flowing space 124 by the baffle 122. An air inlet 125 configured for the air to flow into the electronic cigarette is defined on a side wall of the air flowing space 124 of the body 120. The atomization core 11 is configured to be clasped by the sealing plug 121 and run through both the sealing plug 121 and the baffle 122 to extend to an inside of the oil storage space 123. The air-vent hole 116 is positioned in the air flowing space 124.

Due to the configuration of the baffle 122, the tobacco oil is effectively prevented from entering into the air flowing space 124 from the oil storage space 123. Due to the usage of the sealing plug 121, the airflow only flows into the atomization cavity via the air-vent hole 116 after the air is puffed via the air inlet 125, which improves the utilization ratio of the air. Thus the smoke atomized by the heating wire assembly 113 flows into the user's mouth more freely. It better ensures the amount and the density of the smoke. It can be avoided that the smoke is diluted due to too much air puffed.

In order to obtain better sealing performance, a sealing part (not shown) is defined between an outer wall of the atomization tube 112 and the baffle 122. The sealing part is preferred to be an annular sealing plug.

Specifically, as shown in FIG. 1, the sealing plug 121 comprises a U-shaped connection portion and an abutting portion formed by two open ends of the U-shaped connection portion bending and extending the in opposite directions respectively. The U-shaped connection portion of the sealing plug 121 is embedded into the oil storage element 12, so as to realize a connection between the sealing plug 121 and the oil storage element 12. An end surface of one side of the abutting portion abuts against an end surface of the electrode assembly 111, wherein, the side of the abutting portion faces toward the oil storage element 12.

In the present application, the connection between the atomization core 11 and the oil storage element 12 is detachable. That is, by applying an external force, the atomization core 11 can be pulled out from the sealing plug 121 and the atomization tube 112 can be pulled out from the baffle 12. It makes the quick wearing parts, such as the atomization core 11, be exchangeable freely, so that it is convenient for using. The lifetime of the electronic cigarette is hence prolonged. Meanwhile, the detachable connection between the atomization core 11 and the oil storage element 12 makes it easy to view the tobacco oil. Therefore, it is convenient for users to add the tobacco oil when necessary or change the taste of the tobacco oil. Moreover, it is easy for assembling by means of the detachable connection, and it hence improves producing efficiency.

Further, the oil storage element 12 is transparent, which makes it easier to view the tobacco oil stored in the oil storage element 12.

In addition, there is no limit to the shape of the air-vent hole 116 in the present application. The air-vent hole 116 can either be a circular hole or a waist-shaped hole. The shape of the air-vent hole 116 shown in the first embodiment is circular.

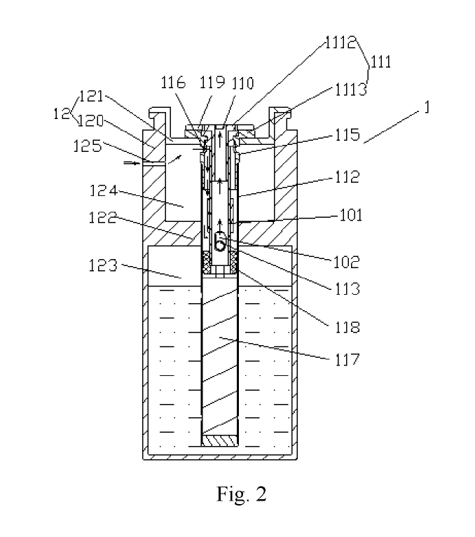

FIG. 2 shows an atomization assembly 1 according to a second embodiment of the present application. The air inlet 125 is a waist-shaped hole, which is different from the first embodiment. When the air inlet 125 is a waist-shaped hole, the inflow speed can be reduced to prevent from generating noise.

In addition, an atomization base 118 configured for placing the heating wire assembly 113 is further defined in the atomization cavity in the second embodiment. Due to the existing of the atomization base 118, the following circumstance can be all avoided: that the tobacco oil in the oil guiding part 117 permeates into the atomization cavity heavily, thus the tobacco oil can't be atomized thoroughly and the tobacco oil hence can be sucked easily.

Especially, in order to obtain a better sealing effect, a sealing element (not shown) is configured between an outer wall of the atomization base 118 and an inner wall of the atomization tube 112. The sealing element is a gasket configured to sheathe the atomization base 118.

Preferably, the atomization base 118 is made of ceramic By using ceramic material, the thermo-tolerance of the atomization base 118 is better. The lifetime of the atomization assembly 1 is hence longer.

In the second embodiment, the rest configurations of the atomization assembly 1 are the same as those in the first embodiment, and there is no need to be repeated here.

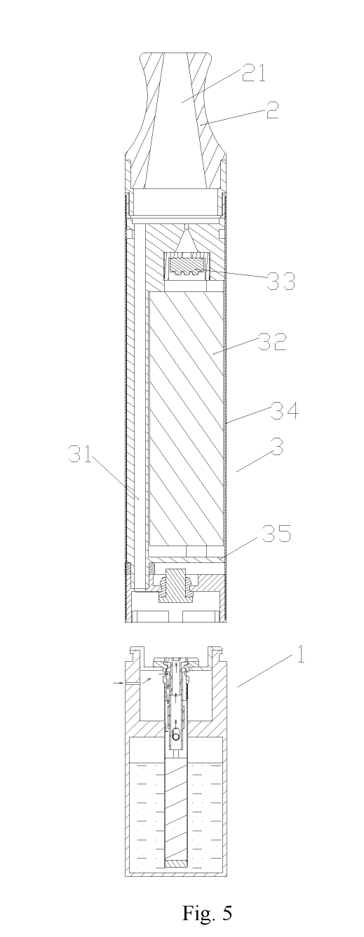

The present application further provides an electronic cigarette comprising a main body. As shown in FIG. 5 (combined with FIGS. 1 and 2 at the same time), a mouthpiece 2, an atomization assembly 1 configured to provide atomized smoke, and a battery assembly 3 configured to power the atomization assembly 1 are defined at the main body. The atomization assembly 1 is defined at one end of the main body, wherein the end of the main body is opposite to the mouthpiece 2.

The atomization assembly 1 comprises an atomization core 11 and an oil storage element 12 configured to store tobacco oil and connected to the atomization core 11. One end of the atomization core 11 is inserted into the oil storage element 12 and a smoke outlet 110 configured to discharge smoke is defined at the other end of the atomization core 11.

The atomization core 11 comprises an electrode assembly 111 electrically connected to the battery assembly 3, an atomization tube 112 configured to sheathe the electrode assembly 111 and inserted into the oil storage element 12, and a heating wire assembly 113 electrically connected to the electrode assembly 111. An atomization cavity configured to contain the heating wire assembly 113 is further defined in the atomization core 11.

A blocking part 115 is defined on an outer surface of the electrode assembly 111. An air-vent hole 116 communicated with both an exterior of the atomization assembly and an interior of the atomization cavity is defined on the electrode assembly 111 and close to one end of the blocking part 115, wherein the end of the blocking part 115 is close to the battery assembly 3. The atomization tube 112 is positioned at the other end of the blocking part 115, wherein the other end of the blocking part 115 is opposite to the battery assembly 3.

Due to that the oil storage element 12 is defined at one end of the main body, opposite to the mouthpiece 2, i.e. the position where the oil storage element 12 is defined is opposite to the mouthpiece 2, the electronic cigarette provided in the present application can ensure that the user can be prevented effectively from sucking the tobacco oil without being atomized.

The atomization assembly 1 is positioned between the battery assembly 3 and the oil storage element 12, that is, the atomization assembly 1 is a little far opposite to the mouthpiece 2. When the user is using the electronic cigarette provided in the present application, the position of the atomization assembly 1 is a little far from the mouth of the user, which makes the user free from being scalded by the heat generated when the atomization assembly 1 atomizes the tobacco oil. The security is hence enhanced effectively. Moreover, the user usually clamps the battery assembly 3 of the present application during smoking, which avoids the circumstance in prior that the user clamps the atomization assembly 1 during smoking. When the user uses the electronic cigarette, the circumstance that the fingers are scalded can hence be avoided. The temperature of a conventional cigarette is simulated effectively and the user experience is hence improved.

Specifically, the mouthpiece 2 positioned outside one end of the battery assembly 3 may be arranged with the battery assembly 3 coaxially. Using this arrangement, the profile of the electronic cigarette imitates that of the conventional cigarette directly, the entire smoke passageway is straighter and it can hence reduce the backlog of tobacco oil.

Alternatively, the mouthpiece 2 may either be arranged at an intermediate section of the battery assembly 3, or be arranged on the battery assembly 3 at a position opposite to the atomization assembly 1.

In the present application, the specific location of the mouthpiece 2 is not limited.

In the present application, the atomization assembly 1 is arranged with the battery assembly 3 coaxially in order to make the entire structure of the electronic cigarette imitate that of the conventional cigarette, to fit to users' using habit and to reduce the backlog of tobacco oil.

Certainly, the specific arrangement is not limited in the present application, for example, the battery assemble 3 and the atomization assembly 1 connected to each other successively can be arranged alternatively.

The atomization assembly 1 and the battery assembly 3 may also be arranged non-coaxially. That is, the atomization assembly 1 and the battery assembly 3 are arranged in parallel.

That is to say, the entire profile of the electronic cigarette is not limited in the present embodiment, as long as the atomization assembly 1 is arranged at a position opposite to the mouthpiece 2.

The specific configuration of the battery assembly 3 of the electronic cigarette will be described in detail in the following combined with the embodiment as shown in FIG. 4.

The battery assembly 3 comprises a battery sleeve 34, a battery 32 contained in the battery sleeve 34, and

a battery support 35 arranged in the battery sleeve 34 and configured to fix the battery 32.

An air outlet 21 is defined on the mouthpiece 2. An airflow passageway 31 configured for the smoke and the airflow to flow is defined in the battery assembly 3. The airflow passageway 31 and the air outlet 21 are connected to each other. The airflow passageway 31, the air outlet 21 and the air inlet 125 are connected to one another. The outflow groove 119 is connected to the airflow passageway 31. In this case, the airflow flows in the airflow passageway in the following order: the airflow inlet 125—the air flowing space 124—the air-vent hole 116—the atomization cavity—the airflow passageway 31—the air outlet 21.

Specifically, the airflow passageway 31 is sealed in the battery assembly 3, that is, the airflow passageway 31 is isolated from other electronic components in the battery assembly 3.

The battery assembly 3 further comprises: a battery 32, an airflow sensor configured to generate a pulse signal, and a microcontroller 33 connected to the battery 32 and the airflow sensor respectively and configured to generate a control signal according to the pulse signal. The microcontroller 33 is connected to the heating wire assembly 113 in order to make the heating wire assembly atomize the tobacco oil according to the control signal. Certainly, the electronic cigarette may also be controlled by a button switch and the like, which is not limited here.

In the present application, in order to make it convenient to replace each part, the mouthpiece 2 and the battery assembly 3 are connected detachably. The atomization assembly 1 and the battery assembly 3 are connected detachably.

Specifically, the connection between the mouthpiece 2 and the battery assembly 3 as well as the connection between the atomization assembly 1 and the battery assembly 3 are threaded connections or clasped connections and the like, and the specific connection is not limited in the present embodiment.

The specific configuration of the atomization assembly 1 of the electronic cigarette in the present application has been described in the above embodiments, and it is not repeated here.

In conclusion, by implementing the atomization assembly 1 and the electronic cigarette of the present invention, the following advantages may be obtained: by means of the arrangement that one end of the atomization core 11 is inserted into the oil storage element 12 while the smoke outlet 110 is defined at the other end of the atomization core 11, the smoke passageway for discharging the smoke never runs through the oil storage region of the oil storage element. Therefore, it is hard for the tobacco oil to be leaked to the smoke passageway and it is hence hard for users to suck the condensed tobacco oil. In addition, by means of the arrangement that the blocking part 115 is defined on the electrode assembly of the atomization assembly 1, the air-vent hole 116 communicated with both an exterior of the electronic cigarette and an interior of the atomization cavity is defined on the electronic assembly and close to one side of the blocking part 115, opposite to the battery assembly 3, and the atomization tube 112 is configured to sheathe one end of the blocking part 116, opposite to the battery assembly, when assembling the atomization tube 112, it can be avoided inserting the atomization tube 112 into the position where the air-vent hole 116 is positioned due to the existing of the blocking part 115. Therefore, it is hard for the air-vent hole 116 to be plugged, which ensures a free air inflow, a stable amount of smoke and a good taste. Moreover, due to the existing of the blocking part 115, there is no need to observe whether the air-vent hole 116 is aligned or not during assembling, thus it is convenient for assembling, and the producing efficiency is hence improved. In addition, as the atomization assembly 1 is configured at one end of the main body, opposite to the mouthpiece, it is not only hard for users to suck the tobacco oil leaked out, but can also avoid the circumstance in the prior art that it is too hot to hold the electronic cigarette because the atomization assembly is defined at the holding position for the fingers.

While the present invention has been described with reference to preferred embodiments, the present application is not limited to above specific embodiments. The above specific embodiments are only illustrative, but not for the purpose of limiting. It will be understood by those skilled in the art that various changes may be made and equivalents may be substituted under the inspiration of the present application without departing from the objective of the present application and the scope of the claims However, all the changes and equivalents will be included within the scope of the appended claims

What is claimed is:

1. An atomization assembly configured to be assembled with a battery assembly (3) to form an electronic cigarette,
wherein the atomization assembly (1) comprises an atomization core (11) and an oil storage element (12) connected to the atomization core (11) and configured to store tobacco oil, wherein one end of the atomization core (11) is inserted into the oil storage element (12) and a smoke outlet (110) configured to discharge smoke is defined at the other end of the atomization core (11);
wherein the atomization core (11) comprises an electrode assembly (111) electrically connected to the battery assembly (3), an atomization tube (112) configured to sheathe the electrode assembly (111) and inserted into the oil storage element (12), and a heating wire assembly (113) electrically connected to the electrode assembly (111);an atomization cavity configured to contain the heating wire assembly (111) is further defined in the atomization core (11);
wherein a blocking part (115) is defined on an outer surface of the electrode assembly (111); an air-vent hole (116) communicated with both an exterior of the atomization assembly (1) and an interior of the atomization cavity is defined on one end of the blocking part (115) on the electrode assembly (111), and the end of the blocking part (115) is close to the battery assembly (3); and the atomization tube (112) is positioned at the other end of the blocking part (115), and the other end of the blocking part is opposite to the battery assembly (3).

2. The atomization assembly of claim 1, wherein the atomization core (11) is detachably connected with the oil storage element (12).

3. The atomization assembly of claim 1, wherein an oil guiding part (117) configured to guide the tobacco oil to the heating wire assembly (113) is defined in one end of the atomization tube (112) and the end of the atomization tube (112) is opposite to the atomization cavity; the tobacco oil is atomized by heating wire assembly (113); and an external wall of the oil guiding part (117) is configured to fit an internal wall of the atomization tube (112).

4. The atomization assembly of claim 1, wherein the oil storage element (12) comprises a body (120) and a sealing plug (121) configured to be detachably covered on an opening of the body (120); a baffle (122) is defined in the body (120); an internal space of the body (120) is divided into an oil storage space (123) and an air flowing space (124) by the baffle (122); an air inlet (125) configured for the air to flow into the electronic cigarette is defined on a side wall of the air flowing space (124) of the body (120);
wherein the atomization core (11) is configured to be clasped by the sealing plug (121) and runs through both the sealing plug (121) and the baffle (122) to extend to an inside of the oil storage space (124); and the air-vent hole (116) is positioned in the air flowing space (124).

5. The atomization assembly of claim 4, wherein a sealing part is defined between an outer wall of the atomization tube (112) and the baffle (122).

6. The atomization assembly of claim 4, wherein the sealing plug (121) comprises a U-shaped connection portion and an abutting portion formed by two open ends of the U-shaped connection portion bending and extending in opposite directions respectively, and the U-shaped connection portion of the sealing plug (121) is embedded in the oil storage element (12).

7. The atomization assembly of claim 1, wherein the air-vent hole (116) is waist-shaped.

8. The atomization assembly of claim 1, wherein an atomization base (118) configured to place the heating wire assembly (113) is further defined in the atomization cavity, and a sealing element is defined between an outer wall of the atomization base (118) and an inner wall of the atomization tube (112).

9. The atomization assembly of claim 8, wherein the atomization base (118) is made of ceramic.

10. The atomization assembly of claim 1, wherein the blocking part (115) is an annular flange protruding outwardly from the electrode assembly (111) in a radial direction.

11. The atomization assembly of claim 1, wherein the blocking part (115) is a plurality of protrusions protruding outwardly from the electrode assembly (111) in a radial direction, and the plurality of protrusions are arranged in the same circle.

12. The atomization assembly of claim 1, wherein the oil storage element (12) is transparent.

13. An atomization assembly configured to be assembled with a battery assembly (3) to form an electronic cigarette,
wherein the atomization assembly (1) comprises an atomization core (11) and an oil storage element (12) configured to store tobacco oil and connected to the atomization core (11), wherein one end of the atomization core (11) is inserted into the oil storage element (12) and a smoke outlet (110) configured to discharge smoke is defined at the other end of the atomization core (11);
wherein the atomization core (11) comprises an electrode assembly (111) electrically connected to the battery assembly (3), an atomization tube (112) configured to sheathe the electrode assembly (111) and inserted into the oil storage element (12), and a heating wire assembly (113) electrically connected to the electrode assembly (111); an atomization cavity configured to contain the heating wire assembly (113) is further defined in the atomization core (11);
wherein a blocking part (115) is defined on an outer surface of the electrode assembly (111); an air-vent hole (116) communicated with both an exterior of the atomization assembly (1) and an interior of the atomization cavity is defined on one end of the blocking part (115) on the electrode assembly (111), and the end of the blocking part (115) is close to the battery assembly (3); the atomization tube (112) is positioned at the other end of the blocking part (115), and the other end of the blocking part (115) is opposite to the battery assembly (3);
wherein the oil storage element (12) comprises a body (120) and a sealing plug (121) configured to be detachably covered on an open end of the body (120); a baffle (122) is defined in the body (120); an internal space of the body (120) is divided into an oil storage space (123) and an air flowing space (124) by the baffle (122); an air inlet (125) configured for air to flow into the electronic cigarette is defined on a side wall of the air flowing space (124) of the body (120);
wherein the atomization core (11) is configured to be clasped by the sealing plug (121) and runs through both the sealing plug (121) and the baffle (122) to extend to an inside of the oil storage space (123); the air-vent hole (116) is positioned in the air flowing space (124); and
wherein the blocking part (115) is a protrusion part protruding outwardly from the electrode assembly (111) in a radial direction.

14. An electronic cigarette comprising a main body, wherein a mouthpiece (2), an atomization assembly (1) configured to provide atomized smoke, and a battery assembly (3) configured to power the atomization assembly (1) are defined at the main body; the atomization assembly (1) is defined at one end of the main body and the end of the main body is opposite to the mouthpiece (2);
wherein the atomization assembly (1) comprises an atomization core (11) and an oil storage element (12) configured to store tobacco oil and connected to the atomization core (11); one end of the atomization core (11) is inserted into the oil storage element (12) and a smoke outlet (110) configured to discharge smoke is defined at the other end of the atomization core (11);
wherein the atomization core (11) comprises an electrode assembly (111) electrically connected to the battery assembly (3), an atomization tube (112) configured to sheathe the electrode assembly (111) and inserted into the oil storage element (12), and a heating wire assembly (113) electrically connected to the electrode assembly (111); an atomization cavity configured to contain the heating wire assembly (113) is further defined in the atomization core (11); and
wherein a blocking part (115) is defined on an outer surface of the electrode assembly (111); an air-vent hole (116) communicated with both an exterior of the atomization assembly (1) and an interior of the atomization cavity is defined on one end of the blocking part (115) on the electrode assembly (111), and the end of the blocking part (115) is close to the battery assembly (3); and the atomization tube (112) is positioned at the other end of the blocking part (115), and the other end of the blocking part (115) is opposite to the battery assembly (3).

15. The electronic cigarette of claim 14, wherein the oil storage element (12) comprises a body (120) and a sealing plug (121) configured to be detachably covered on an open end of the body (120); a baffle (122) is defined in the body (120); an internal space of the body (120) is divided into an oil storage space (123) and an air flowing space (124) by the baffle (122); an air inlet (125) configured for the air to flow into the electronic cigarette is defined on a side wall of the air flowing space (124) of the body (120); and
wherein the atomization core (11) is configured to be clasped by the sealing plug (121) and runs through both the sealing plug (121) and the baffle (122) to extend to an inside of the oil storage space (124); and the air-vent hole (116) is positioned in the air flowing space (124).

16. The electronic cigarette of claim 15, wherein an air outlet (21) is defined on the mouthpiece (2); an airflow passageway (31) provided for the smoke and the air to flow is defined in the battery assembly (3); and the airflow passageway (31), the air outlet (21) and the air inlet (125) are communicated with each other.

17. The electronic cigarette of claim 14, wherein the mouthpiece (2) is detachably connected to the battery assembly (3).

18. The electronic cigarette of claim 14, wherein the connection between any two of the oil storage element (12), the atomization core (11) and the battery assembly (3) is detachable.

19. The electronic cigarette of claim 16, wherein the battery assembly (3) further comprises a battery (32), an airflow sensor configured to generate a pulse signal, and a microcontroller (33) connected to the battery (32) and the airflow sensor respectively and configured to generate a control signal according to the pulse signal; and
wherein the microcontroller (33) is connected to the heating wire assembly (113) in order to make the heating wire assembly (113) atomize the tobacco oil according to the control signal.
